(19) United States
(12) Patent Application Publication
(10) Pub. No.: US 2024/0010204 A1
(43) Pub. Date: Jan. 11, 2024

(54) VEHICLE ASSISTANCE DEVICE

(71) Applicant: Alps Alpine Co., Ltd., Tokyo (JP)

(72) Inventor: Ryo Yoshida, Iwaki (JP)

(73) Assignee: Alps Alpine Co., Ltd., Tokyo (JP)

(21) Appl. No.: 18/348,532

(22) Filed: Jul. 7, 2023

(30) Foreign Application Priority Data
Jul. 8, 2022 (JP) 2022-110119

(51) Int. Cl. B60W 40/08; B60W 50/14

(52) U.S. Cl. CPC B60W 40/08; B60W 50/14; B60W 2540/225; B60W 2050/143; B60W 2554/402; B60W 2554/4041; B60W 2420/42

(57) ABSTRACT

A vehicle assistance device includes an object sensing unit that detects an object around an own vehicle included in a range viewable through a monitoring area set in a part of a field-of-view range of a driver, sensed object information extraction unit and an additional information generation unit that generate additional information regarding the object detected, a driver's line-of-sight sensing unit that detects a line of sight of the driver, a mirror gaze determination unit that determines that movement of the line of sight of the driver detected has stopped in the monitoring area, and an additional information voice generation and output unit that outputs by voice the additional information generated by the additional information generation unit at a time point when stop of the line-of-sight movement is determined.

### RELATED APPLICATION

The present application claims priority to Japanese Patent Application No. 2022-110119, filed on Jul. 8, 2022, the entirety of which is hereby incorporated by reference.

### BACKGROUND

### 1. Field

The present disclosure relates to a vehicle assistance device that provides information useful for driving while traveling.

### 2. Description of the Related Art:

Conventionally, there has been known a vehicular obstacle warning device that calculates a gaze frequency of a driver with respect to a door mirror, a rear-view mirror, or the like, and provides information to the driver according to a result of comparing the calculated gaze frequency with a predetermined value so as to display or output by voice information regarding an obstacle present in the rear of the vehicle, when there is a high need to provide the information (see, for example, JP 2001-260776 A).

### SUMMARY

In the vehicular obstacle warning device disclosed in JP 2001-260776 A described above, after a point of gaze of a driver is detected, information regarding the presence of another vehicle located in the rear of the vehicle is calculated, and then a warning operation is performed according to the gaze frequency. Therefore, there is a problem in that it takes time from when the driver gazes at the door mirror, or the like, until the driver actually confirms the content of the warning operation.

The present disclosure has been made in view of these points, and an object thereof is to provide a vehicle assistance device capable of shortening a time until useful information is provided to a driver while traveling.

In order to solve the above problem, a vehicle assistance device of the present disclosure includes: an obstacle detection unit that detects an obstacle around a vehicle and included in a range viewable through a monitoring area set in a part of a field-of-view range of the driver; an additional information generation unit that generates additional information regarding the obstacle detected by the obstacle detection unit; a line-of-sight detection unit that detects a line of sight of the driver; a line-of-sight movement stop determination unit that determines that movement of the line of sight of the driver detected by the line-of-sight detection unit has stopped in the monitoring area; and, an additional information output unit that outputs by voice the additional information generated by the additional information generation unit, at a time point when the line-of-sight movement stop determination unit determines that a line-of-sight movement has stopped.

Since the additional information regarding an obstacle (e.g. another vehicle or the like) around the vehicle can be obtained by voice immediately when the driver's line-of-sight movement stops, it is possible to shorten the time until the information useful for the driver is obtained.

In addition, in some embodiments, operations by the obstacle detection unit and the additional information generation unit, and operations by the line-of-sight detection unit and the line-of-sight movement stop determination unit, described above, may be performed in parallel. Thus, the additional information can be output without a pause immediately after the line-of-sight movement stop determination.

In addition, in some embodiments, the monitoring area described above may correspond to a minor for confirming the presence of an obstacle located behind the vehicle. Thus, it is possible to obtain detailed information regarding an obstacle when knowing that there is some sort of obstacle by looking at the door mirror or the rear-view minor.

In addition, in some embodiments, a plurality of the monitoring areas described above may correspond to a plurality of field of views having different orientations. Thus, it is possible to obtain information of the obstacle at a plurality of locations where the driver's line-of-sight movement is assumed to stop.

In addition, in some embodiments, the additional information described above may include at least one of a type of the obstacle, a relative speed of the obstacle, and/or a relative position of the obstacle with respect to the vehicle. Thus, it is possible to know the type of the obstacle and the presence or absence of approach by the obstacle toward the vehicle, for which details cannot be confirmed only by viewing the obstacle for a moment, and it is thus possible to easily determine whether the driver needs to pay further attention to the obstacle.

In addition, in some embodiments, the additional information output unit described above may output the additional information from a plurality of speakers, for example, to match a position or orientation of a sound image of an output voice of the additional information with an actual orientation of the obstacle. Thus, it is possible to easily confirm the direction in which the obstacle exists.

### BRIEF DESCRIPTION OF THE DRAWINGS

FIG. 1 is a diagram illustrating a configuration of a vehicle assistance device according to an embodiment of the present disclosure;

FIG. 2 is a diagram illustrating a range including an object to be subjected to additional information generation by the vehicle assistance device;

FIG. 3 is a flowchart illustrating an operation procedure for performing additional information generation by an object sensing and additional information generation unit; and,

FIG. 4 is a flowchart illustrating an operation procedure of performing determination of a driver's gaze and outputting an object information voice.

### DETAILED DESCRIPTION

A vehicle assistance device according to an embodiment of the present disclosure will now be described with reference to the drawings.

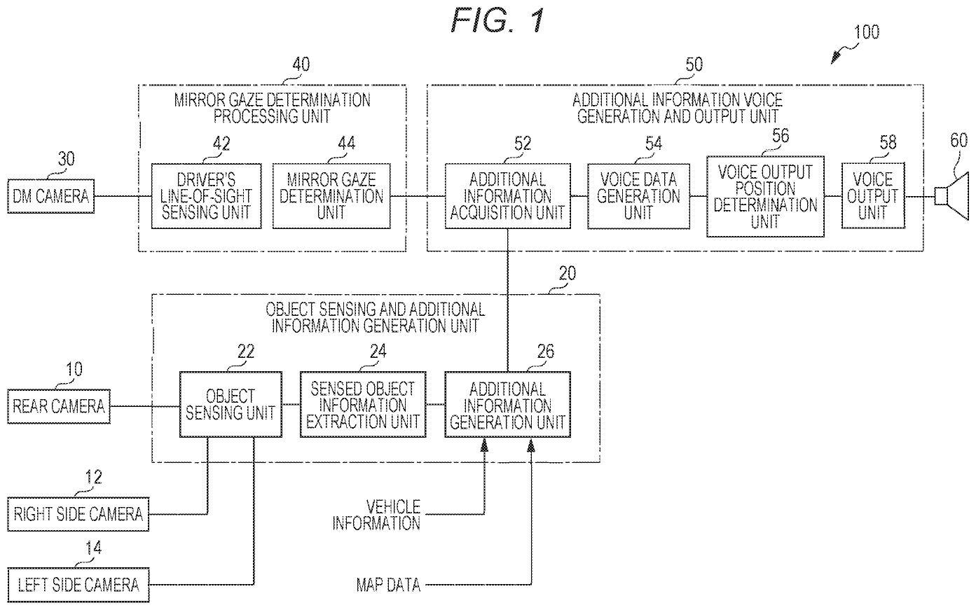

FIG. 1 is a diagram illustrating a configuration of a vehicle assistance device 100 according to an embodiment of the present disclosure. When the driver of a vehicle gazes at any one of the rear-view mirror, the right door mirror, and/or the left door mirror, in order to check the rear of the vehicle while driving, and an object (obstacle) such as a person or a vehicle is reflected in the mirror, the vehicle assistance device 100 performs the operation of generating additional information related to the object, and outputting the additional information by voice, without delay. Here, the additional information is not a vehicle or the like itself as an object directly viewed from the driver, but is information related to the vehicle or the like. For example, when a following vehicle is seen in the minor, the additional information includes information that is difficult to determine by merely glancing at the following vehicle, or information that is difficult to acquire by merely viewing the following vehicle, such as a type of the following vehicle (e.g., general vehicle/truck/motorcycle/emergency vehicle), a traveling speed of the following vehicle, and/or a relative speed in a case where the following vehicle is approaching the vehicle having the vehicle assistance device 100 (“the own vehicle”).

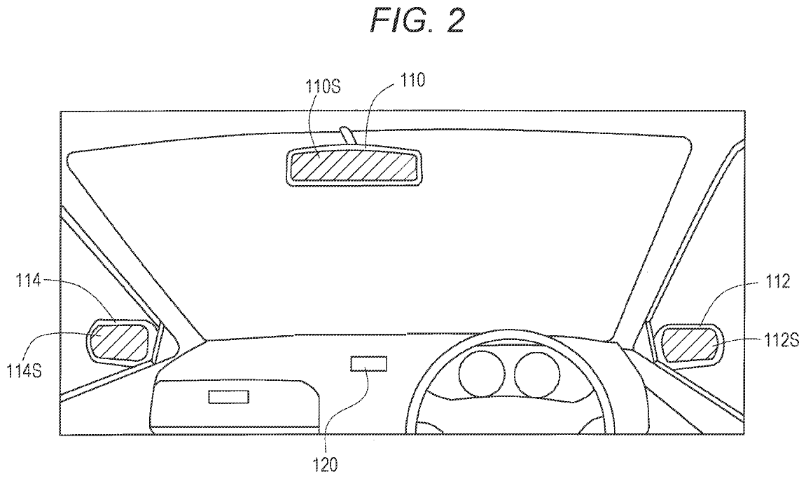

FIG. 2 is a diagram illustrating a range including an object to be subjected to additional information generation by the vehicle assistance device 100. As illustrated in FIG. 2, in a state where the driver sits on the driver's seat and faces forward, any one of a rear-view mirror 110, a right door minor 112, and/or a left door mirror 114 is used to check the rear of the vehicle having the vehicle assistance device 100.

In the present embodiment, a “monitoring area” that is a target for determining the

stop of the line-of-sight movement of the driver is set within the field-of-view range of the driver. In the example illustrated in FIG. 2, the reflective surface of the rear-view minor 110 is set in a monitoring area 110S, the reflective surface of the right door mirror 112 is set in a monitoring area 112S, and the reflective surface of the left door mirror 114 is set in a monitoring area 114S. An object to be monitored is included in any of these monitoring areas 110S, 112S, and 114S, and when the driver gazes at the object, voice output of the additional information is started.

As illustrated in FIG. 1, the vehicle assistance device 100 of the present embodiment may include a rear camera 10, a right side camera 12, a left side camera 14, an object sensing and additional information generation unit 20, a driver monitoring (DM) camera 30, a mirror gaze determination processing unit 40, an additional information voice generation and output unit 50, and a speaker 60. Those skilled in the art will understand that any one ore more of the “units” disclosed and described herein may be implemented with circuitry, a controller, a hardwired processor, and/or a processor configured to execute instructions stored in a memory.

The rear camera 10 is attached to a predetermined position on the rear of the vehicle (for example, above the license plate) and captures an image of the rear of the own vehicle. The imaging range of the rear camera 10 includes a range that can be viewed through the rear-view mirror 110.

The right side camera 12 is attached to a predetermined position on the right side of the vehicle (for example, below the right door minor 112), and captures an image of the right rear of the own vehicle. The imaging range of the right side camera 12 includes a range that can be viewed through the right door minor 112.

The left side camera 14 is attached to a predetermined position on the left side of the vehicle (for example, below the left door mirror 114), and captures an image of the left rear of the own vehicle. The imaging range of the left side camera 14 includes a range that can be viewed through the left door mirror 114.

The object sensing and additional information generation unit 20 senses an object to be monitored and generates additional information regarding the object. For this purpose, the object sensing and additional information generation unit 20 includes an object sensing unit 22, a sensed object information extraction unit 24, and an additional information generation unit 26. The object sensing unit 22 senses an object from images obtained by image capturing by the rear camera 10, the right side camera 12, and the left side camera 14. Here, a sensing target is an object such as a following vehicle that the driver needs to be careful of, and the object sensing unit 22 determines the presence or absence of the object by cutting out a partial image having a characteristic (e.g., shape, color, or the like) specific to the object from the entire image by a method such as pattern recognition. The sensed object information extraction unit 24 extracts object information including a type (e.g., person/general vehicle/truck/motorcycle/emergency vehicle), an object moving speed, and an azimuth of the sensed object. The additional information generation unit 26 generates additional information of the sensed object. For example, additional information is generated including a relative speed difference with respect to the own vehicle, a relative distance, presence or absence of an emergency vehicle, presence or absence of a merging vehicle, and the like. The additional information is generated by using not only the extracted object information, but also vehicle information, including a speed of the own vehicle and the like, map data, including the shape of a road for merging, or the like, etc. In addition, the distance to the object and the speed of the object can be known on the basis of the size of each object sensed by the object sensing unit 22, a temporal change thereof, and the like.

The driver monitoring camera 30 images the entire face of the driver, including the driver's eyeballs. For example, an infrared camera may be used.

The minor gaze determination processing unit 40 determines whether the driver gazes at one or more of the rear-view mirror 110, the right door minor 112, and/or the left door mirror 114. For this purpose, the minor gaze determination processing unit 40 includes a driver's line-of-sight sensing unit 42 and a mirror gaze determination unit 44. The driver's line-of-sight sensing unit 42 senses the driver's line of sight by determining the orientations of the driver's face, particularly the right and left eyeballs from the driver's face image, and more particularly, the image of the right and left eyeballs obtained by image capturing by the driver monitoring camera 30. The minor gaze determination unit 44 determines whether the driver gazes at one ore more of the rear-view minor 110, the right door mirror 112, and/or the left door mirror 114. For example, it is determined whether the gaze position of the driver is included in any of the monitoring areas 110S, 112S, and 114S (FIG. 2). Note that, in the present embodiment, when the driver confirms the presence of an object reflected in the rear-view mirror 110 or the like, additional information of the object is quickly output by voice, and therefore, it is sufficient for the driver to know that the object is reflected in the rear-view mirror 110 or the like, and it is not necessary to perform a long or extend gaze. For example, there may be a case where it is determined that the driver is gazing when the driver's line-of-sight movement has stopped in any of the monitoring areas 110S, 112S, and 114S for 0.5 seconds, or more.

The additional information voice generation and output unit 50 generates and outputs a voice signal of additional information regarding an object present at a gaze destination of the driver. For this purpose, the additional information voice generation and output unit 50 includes an additional information acquisition unit 52, a voice data generation unit 54, a voice output position determination unit 56, and a voice output unit 58. The additional information acquisition unit 52 acquires, from the object sensing and additional information generation unit 20, the additional information regarding an object included in the monitoring area 110S, or the like, in which it is determined that the driver is gazing by the mirror gaze determination unit 44. The voice data generation unit 54 generates voice data for outputting the content of the acquired additional information by voice. The voice output position determination unit 56 determines the position of the object, which is a target of voice output, as a voice output position. The voice output unit 58 may output a voice signal corresponding to voice generation data from one or more of a plurality of speakers 60, so that the position of the sound image becomes the same as the position of the object determined by the voice output position determination unit 56. Note that, instead of matching the position of the object with the position of the sound image, the orientation of the object and the orientation of the sound image may be matched.

The rear camera 10, the right side camera 12, the left side camera 14, and the object sensing unit 22 described above correspond to an obstacle detection unit, the sensed object information extraction unit 24 and the additional information generation unit 26 correspond to an additional information generation unit, the driver monitoring camera 30 and the driver's line-of-sight sensing unit 42 correspond to a line-of-sight detection unit, the mirror gaze determination unit 44 corresponds to a line-of-sight movement stop determination unit, and the additional information voice generation and output unit 50 and the speaker 60 correspond to an additional information output unit, respectively.

The vehicle assistance device 100 of the present embodiment has the above configuration, and next will be described the operation thereof.

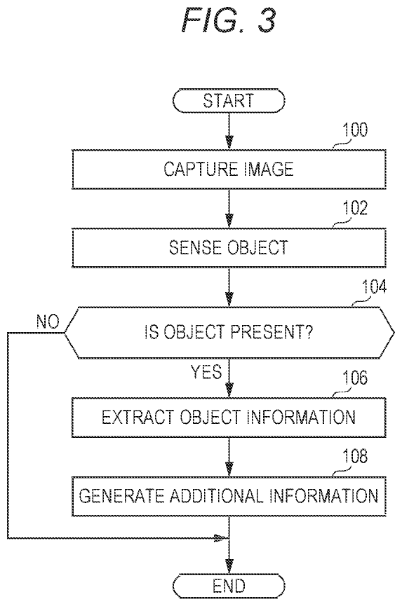

FIG. 3 is a flowchart illustrating an operation procedure for performing additional information generation by the object sensing and additional information generation unit 20. This operation procedure is repeated at regular time intervals. In addition, this operation procedure is performed in parallel, separately from the operation of the mirror gaze determination processing unit 40, or the like.

First, when image capturing is performed by the rear camera 10, the right side camera 12, and/or the left side camera 14 (step 100), the object sensing unit 22 cuts out a partial image having a characteristic specific to the object from the image obtained by the image capturing to sense an object, which is a target of output of the additional information voice (step 102). Note that it is not necessary to set the entire imaging range of each camera as an object sensing target, and it is sufficient to set only the range reflected in each of the monitoring areas 110S, 112S, and 114S (FIG. 2) as a sensing target.

Next, the object sensing unit 22 determines whether an object has been sensed (step 104). In a case where the sensed object does not exist, a negative determination is made, and a series of operations related to the additional information generation ends.

In addition, in the case where an object is sensed, a positive determination is made in the determination in step 104. Next, the sensed object information extraction unit 24 extracts object information (e.g., type, moving speed, azimuth, and the like) regarding the sensed object (step 106). In a case where there is a plurality of sensed objects, the object information generation operation is performed for each object.

Next, the additional information generation unit 26 generates additional information regarding the object for which the object information has been extracted (step 108). In this way, a series of operations related to the additional information generation ends.

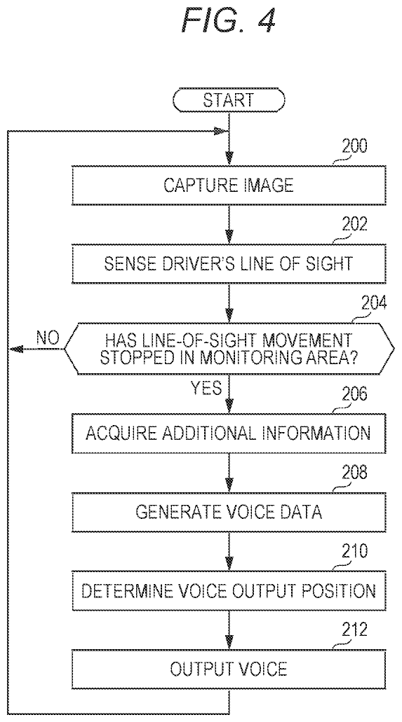

FIG. 4 is a flowchart illustrating an operation procedure of performing determination of a driver's gaze and outputting an object information voice. When the image is captured by the driver monitoring camera 30 (step 200), the driver's line-of-sight sensing unit 42 senses the driver's line of sight from the driver's face image obtained by the image capturing (step 202). In addition, the mirror gaze determination unit 44 determines whether the driver is gazing at any one or more of the rear-view mirror 110, the right door mirror 112, and/or the left door mirror 114 (for example, whether the movement of the driver's line of sight has stopped in any of the monitoring areas 110S, 112S, and 114S for 0.5 seconds, or more (FIG. 2)) (step 204). In a case where the line-of-sight movement has not been stopped, a negative determination is made, and the processing returns to step 200 to repeat the image capturing operation by the driver monitoring camera 30.

In addition, in a case where the driver's line-of-sight movement has stopped, a positive determination is made in the determination in step 204. Next, the additional information acquisition unit 52 acquires, from the additional information generation unit 26, the additional information corresponding to an object included in the monitoring area where the line-of-sight movement has stopped (being gazed at) (step 206).

Next, the voice data generation unit 54 generates voice data including the acquired additional information (step 208). In addition, the voice output position determination unit 56 determines the position of the object as a voice output position (step 210).

Next, the voice output unit 58 outputs a voice corresponding to the voice data from one or more of the plurality of speakers 60 so that the sound can be heard from the position or direction of the object (step 212).

For example, described below are conceivable exemplary combinations of the generated additional information and the generated voice data.

(1) Additional information: An object is a general vehicle and is approaching at a distance of 150 m from the own vehicle, and a traveling speed of the object is 120 km/h, at a speed difference of 15 km/h. The content of the output voice may be: “A general vehicle 150 m behind is approaching at a speed difference of 15 km/h at 120 km/h”.

(2) Additional information: An object is a motorcycle and is approaching at a distance of 100 m from the own vehicle, and a traveling speed of the object is 140 km/h, at a speed difference of 35 km/h. The content of the output voice may be: “A motorcycle 100 m behind is approaching at a speed difference of 35 km/h at 140 km/h”.

(3) Additional information: An object is an emergency vehicle at a distance of 120 m from the own vehicle, and a traveling speed of the object is 70 km/h. The content of the output voice may be: “An emergency vehicle is approaching from 120 m behind. Please make way and stop”.

After voice output, the processing returns to step 200 to repeat the image capturing operation by the driver monitoring camera 30.

As described above, with the vehicle assistance device 100 of the present embodiment, since the additional information regarding the object around the own vehicle can be obtained by voice immediately when the driver's line-of-sight movement stops, it is possible to shorten the time until the information useful for the driver is obtained.

In particular, by performing the object sensing and additional information generation operation, and the line-of-sight sensing and line-of-sight movement stop determination (gaze determination) operation in parallel, it is possible to output the additional information by voice, without a pause, immediately after the line-of-sight movement stop determination.

In addition, by providing a monitoring area corresponding to a mirror for confirming the presence of an object located behind the own vehicle, when looking at the door mirror (right door minor 112, left door mirror 114) or the rear-view mirror 110 and knowing that some sort of object is approaching, it is possible to obtain detailed information regarding this object.

In addition, by setting a plurality of monitoring areas corresponding to a plurality of field of views having different orientations, it is possible to obtain information of an object at a plurality of locations where the driver's line-of-sight movement is assumed to stop.

In addition, by including the type of an obstacle, the relative speed, the relative position, and the like of the obstacle, with respect to the own vehicle, in the additional information to be output by voice, it is possible to know the type of the object and the presence or absence of approach to the own vehicle with respect to the object for which details cannot be confirmed only by viewing the object for a moment, and it is possible to easily determine whether the driver needs to pay attention to the object.

In addition, by outputting the voice including the additional information from one or more of the plurality of speakers 60, the position and orientation of the sound image of the output voice are matched with the actual position and orientation of the object, so that the direction in which the object exists can be easily confirmed.

Note that the present disclosure is not limited to the above-described embodiment, and various kinds of modifications can be made within the scope of the gist of the present disclosure. For example, in the above-described embodiment, the object existing behind the own vehicle is sensed through the mirror, but a monitoring area may be set at a position other than the mirror (e.g. a part or the whole of the windshield illustrated in FIG. 2), and the object existing in the monitoring area may be sensed when the driver's line-of-sight movement is stopped in the monitoring area. In this case, it is sufficient if a camera having an imaging range corresponding to the added monitoring area is added.

In addition, in a case of confirming an object behind the own vehicle, and in a case of adopting an electronic mirror that displays a rear image captured by a camera on a display device, instead of a minor having a mirror surface, by setting a screen of the display device as a monitoring area, similar object sensing and line-of-sight sensing become possible, and voice output of additional information of the object can be obtained with the same processing content.

In addition, in the above-described embodiment, the additional information is output by voice when the object behind the own vehicle is sensed, but the additional information may be output by voice only when the object is approaching the own vehicle.

As described above, according to the present disclosure, since the additional information regarding an obstacle (object) around the own vehicle can be obtained by voice immediately when the driver's line-of-sight movement stops, it is possible to shorten the time until the information useful for the driver is obtained.

Specific embodiments and specific examples of the present disclosure have been described above with reference to the attached drawings. The specific embodiments and specific examples described above are only specific examples of the present disclosure, which are used to understand the present disclosure, rather than limit the scope of the present disclosure. Those skilled in the art can make various modifications, combinations and reasonable omissions of elements in specific embodiments and specific examples based on the technical ideas of the present disclosure, and the embodiments thus obtained are also included in the scope of the present disclosure. For example, the above-mentioned embodiments and specific examples may be combined with each other, and the combined embodiments are also included in the scope of the present disclosure. Therefore, it is intended that this disclosure not be limited to the particular embodiments disclosed, but that the invention will include all embodiments falling within the scope of the appended claims.

What is claimed is:

1. A vehicle assistance device for providing information useful for a driver while traveling, the vehicle assistance device comprising:
an obstacle detection unit configured to detect an obstacle around a vehicle included in a range viewable through a monitoring area set in a part of a field-of-view range of the driver;
an additional information generation unit configured to generate additional information regarding the obstacle detected by the obstacle detection unit;
a line-of-sight detection unit configured to detect a line of sight of the driver;
a line-of-sight movement stop determination unit configured to determine that movement of the line of sight of the driver detected by the line-of-sight detection unit has stopped in the monitoring area; and
an additional information output unit configured to output by voice the additional information generated by the additional information generation unit at a time point when the line-of-sight movement stop determination unit determines that a line-of-sight movement has stopped.

2. The vehicle assistance device according to claim 1, wherein operations by the obstacle detection unit and the additional information generation unit, and operations by the line-of-sight detection unit and the line-of-sight movement stop determination unit are performed in parallel.

3. The vehicle assistance device according to claim 1, wherein the monitoring area corresponds to a mirror for confirming presence of the obstacle located behind the own vehicle.

4. The vehicle assistance device according to claim 1, wherein a plurality of the monitoring areas correspond to a plurality of field of views having different orientations.

5. The vehicle assistance device according to claim 1, wherein the additional information includes at least one of: a type of the obstacle, a relative speed of the obstacle, and a relative position of the obstacle, with respect to the vehicle.

6. The vehicle assistance device according to claim 1, wherein the additional information output unit outputs the additional information from one or more of a plurality of speakers to match a position or orientation of a sound image of an output voice of the additional information with an actual orientation of the obstacle.
